(19) United States
(12) Patent Application Publication
(10) Pub. No.: US 2007/0254572 A1
(43) Pub. Date: Nov. 1, 2007

(54) Apparatus for stunning animal

(76) Inventors: Frank J. Criscione II, Kansas City, MO (US); Antoine J. H. Winkelmolen, Shawnee, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/369,082

(22) Filed: Mar. 6, 2006

(51) Int. Cl. A22B 3/06

(52) U.S. Cl. 452/58

(57) ABSTRACT

An apparatus (10) and a method for stunning an animal, such as a chicken or other domesticated fowl, prior to performing one or more other processing operations on the animal, wherein the length of a path that the animal travels during exposure to the stunning force is variable. Varying the length of the path allows for compensating for variations in the speed with which the animal is moved along the path. By varying the length of the path in proportion to the variation in the speed, the time during which the animal is exposed to the stunning force can be maintained substantially constant, thereby avoiding the undesirable effects of over- and underexposure.

### BACKGROUND OF THE INVENTION

1. Field of the Invention

The present invention relates to devices and methods for stunning, or relaxing, animals, particularly poultry, during processing operations. More specifically, the present invention concerns a device and a method for stunning an animal, such as a chicken or other domesticated fowl, prior to performing one or more other processing operations on the animal, wherein the length of a path that the animal travels during exposure to the stunning force is variable.

2. Background of the Invention

In the processing of animals, particularly poultry, one processing operation involves stunning the animal in order to relax and stabilize it and thereby facilitate one or more subsequent processing operations. Typically, stunning the animal is accomplished by exposing it to a stunning force in the form of an electric current for an established period of time. Too little current or too short of an exposure are undesirable because the animal may be insufficiently stunned, making the subsequent processing operations, such as killing the animal, more difficult. Too much current or too long of an exposure are also undesirable because either can, for example, cause the animal's heart to burst or cause the animal's feathers to set, making subsequent processing operations, such as eviscerating or defeathering, more difficult.

The animals move substantially automatically through the various processing operations on a transport system, such as a conveyor. It sometimes happens that a problem with the transport system or with one of the processing operations causes a slowdown in movement that affects part or all of the system. Such a slowdown can cause the animals to be exposed to the electric current for longer than the established time period, resulting in the aforementioned undesirable effects.

### SUMMARY OF THE INVENTION

The present invention provides an apparatus and a method for stunning an animal, such as a chicken or other domesticated fowl, prior to performing one or more other processing operations on the animal, wherein the length of a path that the animal travels during exposure to the stunning force is variable. Varying the length of the path allows for compensating for variations in the speed with which the animal is moved along the path. By varying the length of the path in proportion to the variation in the speed, the time during which the animal is exposed to the stunning force can be maintained substantially constant, thereby avoiding the undesirable effects of over- and underexposure.

The apparatus is used in combination with an otherwise substantially conventional conveyor for transporting the animal into and through the apparatus. The animal is suspended from a shackle which is coupled and movable with the conveyor. The conveyor substantially automatically moves the shackled animal along the aforementioned path through the various processing operations, including the stunning operation performed by the apparatus.

Broadly, the device comprises a first electrode and a second electrode, wherein the animal extends substantially between the first electrode and the second electrode while moving along the path through the apparatus and is thereby exposed to an electric current for an established time period. The length of the first electrode relative to the path can be changed. When the speed at which the animal moves along the path changes, the length of the first electrode relative to the path is changed by a proportional amount to maintain the established time period for exposure.

In one embodiment, the length of the first electrode is changed relative to the path by changing the path relative to the first electrode. More specifically, the path extends substantially parallel to the first electrode in a first direction, turns, and extends substantially parallel to the first electrode in a second direction, wherein the second direction is substantially opposite the first direction. The first electrode is horizontally repositionable relative to the conveyor in order to change the length of operational association between the first electrode and the path.

In a second embodiment, the length of the first electrode is changed relative to the path by physically shortening the length of the first electrode. More specifically, the first electrode is horizontally extendable and retractable in the direction of the path.

In an implementation of either embodiment, an electronic controller substantially automatically detects the change in speed of the animal moving along the path and substantially automatically causes the appropriate change in the length of the first electrode relative to the path.

These and other novel features of the present invention are described in more detail in the section titled DETAILED DESCRIPTION, below.

### BRIEF DESCRIPTION OF THE DRAWINGS

A preferred embodiment of the present invention is described in detail below with reference to the attached drawing figures, wherein:

FIG. 1 is an isometric view of the apparatus of the present invention, shown in operational association with a conveyor;

FIG. 2 is a side elevation view of the apparatus and the conveyor;

FIG. 3 is a front view of the apparatus and the conveyor;

FIG. 4 is a fragmentary front view of wheels associated with a horizontal adjustment subsystem of the apparatus;

FIG. 5 is an exploded isometric view of a locking mechanism associated with the horizontal adjustment subsystem;

FIG. 6 is a plan view of the apparatus in a normal position relative to the conveyor;

FIG. 7 is a plan view of the apparatus in an adjusted position relative to the conveyor;

FIG. 8 is a plan view of a second embodiment of the apparatus and the conveyor, wherein a first electrode of the apparatus is shown with a normal length; and

FIG. 9 is a plan view of the second embodiment of the apparatus and the conveyor, wherein the first electrode of the apparatus is shown with an adjusted length.

### DETAILED DESCRIPTION

With reference to the figures, an apparatus 10 and method for stunning an animal is herein described, shown, and otherwise disclosed in accordance with a preferred embodiment of the present invention. Broadly, the apparatus 10 and the method allow for stunning an animal, such as a chicken or other domesticated fowl, prior to performing one or more other processing operations on the animal, wherein the length of a path that the animal travels during exposure to the stunning force is variable. Varying the length of the path allows for compensating for variations in the speed with which the animal is moved along the path. By varying the length of the path of exposure to the current in proportion to the variation in the speed, the time during which the animal is exposed to the stunning force can be maintained substantially constant, thereby avoiding the undesirable effects of over- and underexposure. This ideal established time period will vary depending on the nature of the animal and other factors. In one application, for example, involving typical chickens undergoing conventional processing, the time period is approximately between 7 seconds and 10 seconds.

In some systems, a slowdown in operation decreases the speed with which the animal moves along the path and thereby increases the time during which the animal is exposed to the stunning force. In an embodiment of the present invention, however, when such a slowdown occurs, the length of the path traveled by the animal relative to the stunning force can be shortened in order to compensate for the decrease in the speed. As a result, the time during which the animal is exposed to the stunning force is maintained substantially constant.

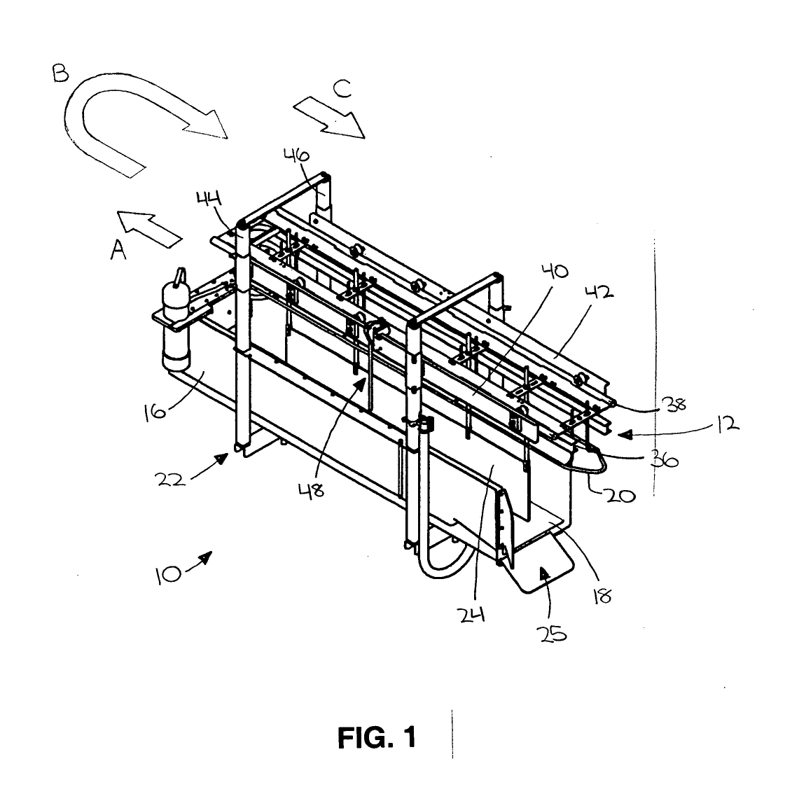

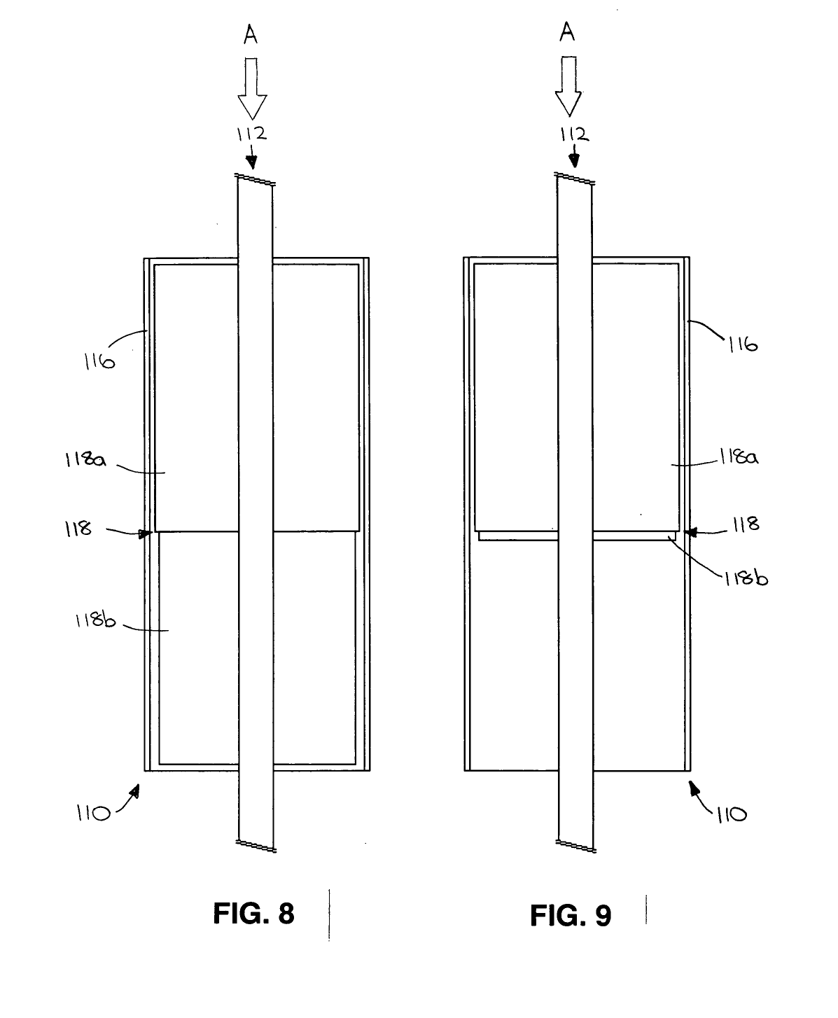

The apparatus 10 is used in combination with an otherwise substantially conventional conveyor 12 or other transport system for transporting the animal into and through the apparatus 10. More specifically, the animal is suspended from a shackle or otherwise secured to or by a device which is coupled and movable with the conveyor 12. The conveyor 12 substantially automatically moves the shackled animal along the path through the various processing operations, including the stunning operation performed by the apparatus 10. In one embodiment, shown in FIGS. 1-7, the defined path through the apparatus 10 of the present invention involves movement in a first direction A to enter the apparatus 10, a 180 degree turn B, and movement in a second direction C, which is substantially opposite the first direction A, to exit the apparatus 10. In a second embodiment, shown in FIGS. 8 and 9, the defined path is substantially linear, e.g., in the first direction A only. Because the conveyor 12 corresponds with (i.e., defines or follows) the path, these two terms may, when appropriate, be used interchangeably herein.

Referring particularly to FIGS. 1-7, the apparatus 10 broadly comprises a movable housing 16, a first electrode 18, a liquid conductor (not shown), a second electrode 20, and a movement and positioning system 22 for moving the housing 16. The path overlap between the conveyor 12 and the first electrode 18 is controlled by moving the housing 16. The housing 16 contains at least the first electrode 18 and the liquid conductor, and substantially prevents accidental contact therewith during operation of the apparatus 10. In one embodiment, the housing 16 has a substantially rectangular shape and is constructed of fiberglass, but it will be understood that the housing may present substantially any suitable shape and may be constructed of substantially any corrosion-resistant, non-conducting, and otherwise suitable material or combination of materials, such as plastic.

In one embodiment, the housing 16 further includes a divider 24 and one or more guide members 25. The divider 24 is a partition for maintaining separation between animals traveling in the first direction A and animals traveling in the second direction B through the apparatus 10. The divider 24 is constructed of any suitable non-conducting material, such as plexiglass, plastic, or fiberglass. The guide members 25 extend angularly outward from at least the entrance to the housing 16 to assist in guiding, or directing, the animals into the apparatus 10.

The first electrode 18, the liquid conductor, and the second electrode 20, in combination with the animal, provide a complete electrical circuit with an electrical power source (not shown). In one embodiment, the first electrode 18 is a substantially rectangular plate, constructed of stainless steel or another suitable electrical conductor, laid substantially flat on or spaced slightly apart from a bottom of the housing 16. The first direction A and the second direction C are both substantially parallel to an upper surface of the first electrode 18. The liquid conductor is a salt solution covering the first electrode 18 to a depth of approximately between 0.1 and 0.4 inches. The liquid conductor improves electrical contact between the animal and the first electrode 18 by wetting the relevant portions of the animal, e.g., the head and neck if the animal is suspended upside-down from the shackle. The second electrode 20 is provided by the conveyor 12 or by a structure located substantially adjacent to the conveyor 12. When one end of the animal, e.g., the head, is in contact with the liquid conductor or otherwise in direct or indirect contact with the first electrode 18, and the other end, e.g., the legs, is in contact with the metal shackle or otherwise in direct or indirect contact with the second electrode 20, the animal's body completes the electrical circuit and allows current to flow between the first and second electrodes 18,20 through the animal's body, and thereby provides the stunning effect.

The movement and positioning system 22 allows for moving and positioning at least the housing 16, and the first electrode 18 and the conducting liquid contained therein, relative to the conveyor 12 (and the animals transported thereon). The movement and positioning system 22 includes a vertical adjustment subsystem 26 and a horizontal adjustment subsystem 28.

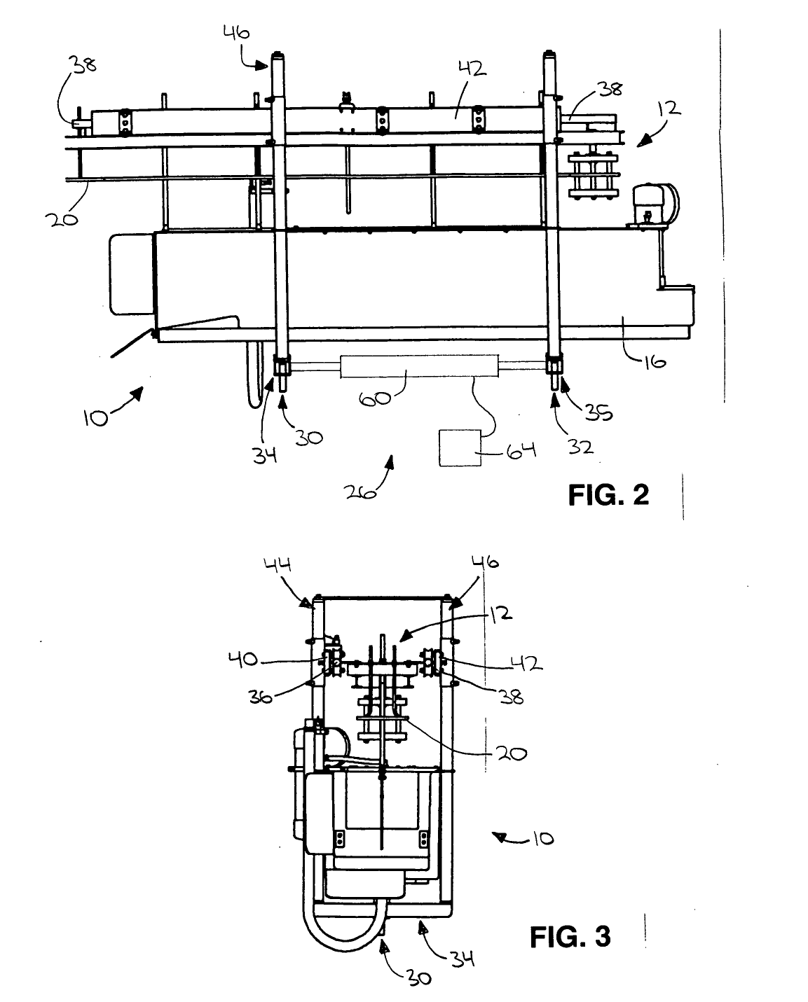

In one embodiment, the vertical adjustment subsystem 26, best seen in FIG. 2, includes first and second height adjustment mechanisms 30,32, in the form of threaded members, each being associated with a respective first and second lower lateral crossmembers 34,35 located beneath the housing 16. The height adjustment mechanisms 30,32 each extend between a respective one of the first and second lower lateral crossmembers 34,35 and an underside of the housing 16. When it is desired to change the vertical position of the housing 16 relative to the conveyor 12, such as when larger or smaller animals are being processed, the height adjustment mechanisms 30,32 are actuated to provide more or less separation, as appropriate, between the vertically-fixed lower lateral crossmembers 34,35 and the vertically-moveable housing 16, thereby raising or lowering the housing 16. Furthermore, the height adjustment mechanisms 30,32 are independently adjustable to allow for leveling the housing 16 relative to, for example, the conveyor 12. In other embodiments, the height adjustment members 30,32 are hydraulic, pneumatic, mechanical, or electrical in nature.

In one embodiment, the horizontal adjustment subsystem 28, best seen in FIG. 3, includes first and second rails 36,38, first and second upper longitudinal cross-members 40,42, first and second pairs of suspension members 44,46, and a locking mechanism 48. The first and second rails 36,38 are located parallel and adjacent to the first and second directions A,B, respectively, of the path of the conveyor 12. In one embodiment, the first and second rails 36,38 are substantially tubular, i.e., circular in cross-section, but it will be understood that the first and second rails 36,38 may present substantially any suitable shape, including cross-sectional shape.

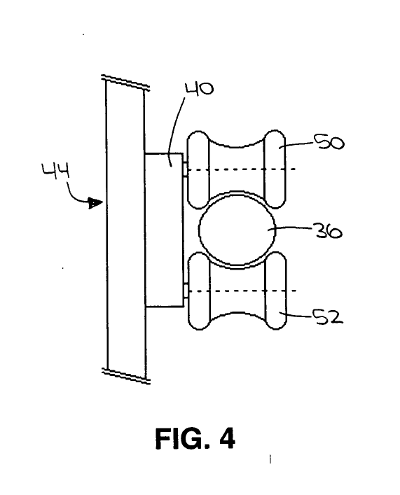

The first and second upper longitudinal crossmembers 40,42 cooperate with the first and second rails 36,38, respectively, in such a manner as to allow for horizontal movement of the crossmembers 40,42 along the rails 36,38. In one embodiment, each crossmember 40,42 is associated with a respective one of the rails 36,38 by one or more wheels that roll upon the respective rail 36,38. As shown in FIG. 4, for example, each crossmember 40,42 includes at least two spaced-apart sets of an upper wheel 50 and a lower wheel 52, with each wheel 50,52 being located above and below, respectively, the respective rail 36,38. In other embodiments, the crossmembers 40,42 slide directly upon the rails 36,38, or slide over bearings interposed between the crossmembers 40,42 and the rails 36,38. Each crossmember 40,42 is also fixedly coupled with the upper portions of a respective pair of suspension members 44,46. The lower portions of the suspension members 44,46 are fixedly coupled with respective ends of the lower lateral crossmembers 34,35 which support the housing 16, such that the housing 16 moves horizontally with the suspension members 44,46 and the upper longitudinal crossmembers 40,42 relative to the rails 36,38.

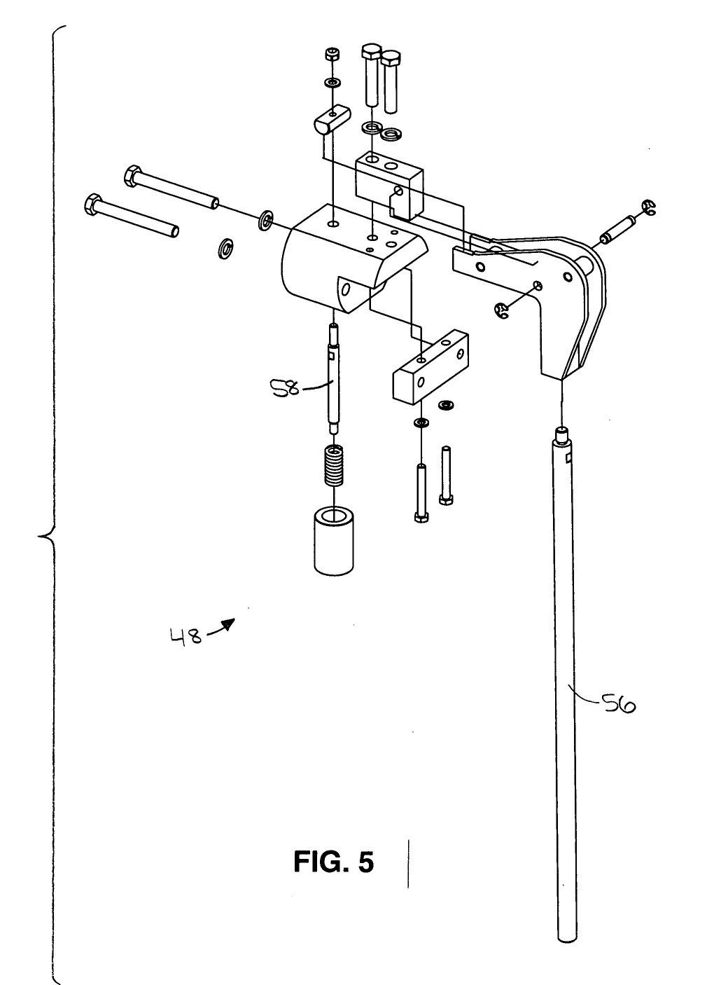

As shown in FIG. 5, the locking mechanism 48 allows for selectively locking the upper longitudinal crossmembers 40,42 in a particular horizontal position relative to the rails 36,38. This has the effect of locking the housing 16 in a particular horizontal position relative to the conveyor 12. In one embodiment, the locking mechanism 48 includes a lever 56 which is hingedly coupled with one of the upper longitudinal crossmembers 40 and which presents a spring-biased pin 58. An upper surface of the respective rail 36 presents a plurality of detents 62, best seen in FIG. 7, for receiving an end of the pin 58. When it is desirable to lock the housing 16 in a particular position relative to the conveyor 12, the pin 58 is aligned with a corresponding one of the detents 62 in the non-movable rail 36 and then the lever 56 is actuated to insert the end of the pin 58 into the detent 62, thereby preventing further horizontal movement until the lever 56 is actuated to withdraw the end of the pin 58.

The plurality of the detents 62 in the rail 36 are spaced a determined distance apart from each other along a substantially horizontal line. The determined distance corresponds to a particular speed of the conveyor 12 measured in birds per minute (BPM). In one embodiment, the detents 62 are spaced approximately six inches apart Because the conveyor's path is doubled-over within the apparatus 10, due to the 180 degree turn C, this spacing corresponds to approximately twelve inches of path. At a typical normal conveyor speed, twelve inches of path corresponds to 2 BPM; and so, for example, a decrease or increase in conveyor speed of 2 BPM can be compensated for by horizontally repositioning the housing 16 by the distance of one detent 62.

Thus, whenever the speed of the conveyor 12 changes, such as when a slowdown occurs or ends, the relative horizontal positioning of the upper longitudinal crossmembers 40,42 and the rails 36,38, and thus that of the housing 16 and the conveyor 12, can be changed to shorten or lengthen the path traveled by the animal relative to the stunning force and thereby control the amount of time that the animal is exposed to the stunning force. By measuring the change in BPM of the conveyor's speed, the housing 16 can be moved a corresponding horizontal distance to compensate for the change and thereby achieve a substantially constant time of exposure.

In one embodiment, this change in path length is accomplished by manually repositioning the housing 16 relative to the conveyor 12, i.e., physically unlocking the locking mechanism 48 (in the manner described above), pushing the housing 16, suspension members 44,46, or lower lateral crossmembers 34,35 to cause the upper longitudinal crossmembers 40,42 to move horizontally upon the rails 36,38 to create the desired path length, and then re-engaging the locking mechanism 48. In another embodiment, this change in position is facilitated by an assistance mechanism 60, which may be hydraulic, pneumatic, mechanical, and/or electrical in nature, the actuation of which causes the upper longitudinal crossmembers 40,42 to substantially automatically move horizontally upon the rails 36,38. In yet another embodiment, the entire process is accomplished substantially automatically by a microcontroller 64 which monitors the speed of the conveyor system 12 and substantially automatically actuates the assistance mechanism 60 to adjust the path length accordingly.

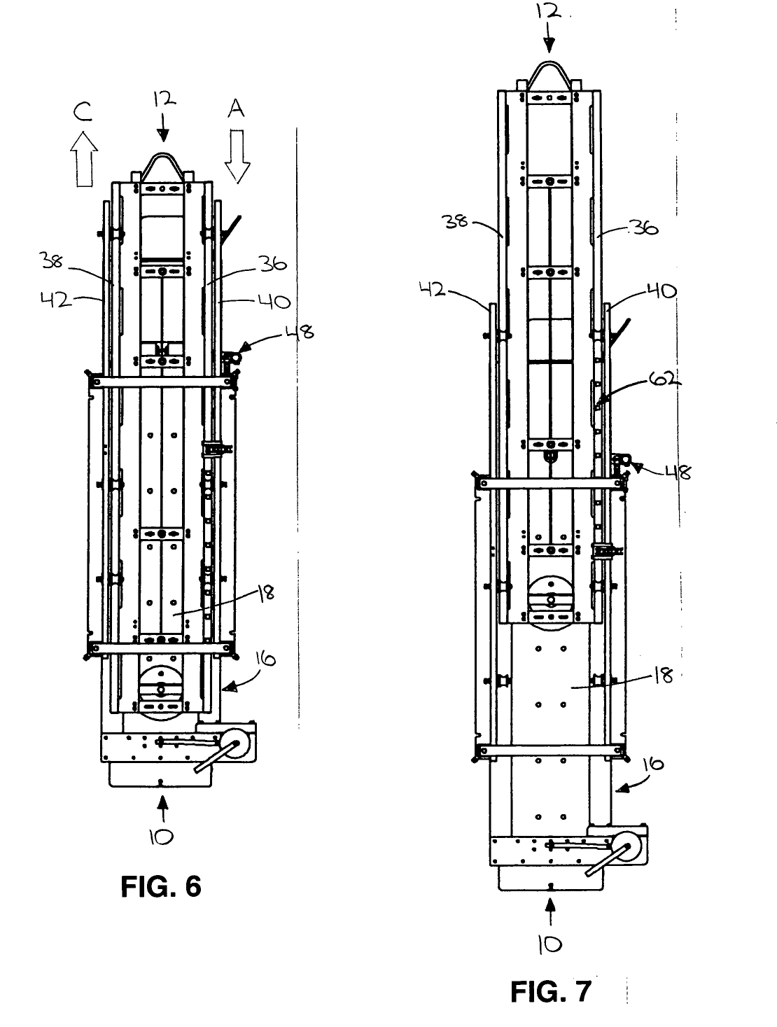

In exemplary, but non-limiting, use and operation, the apparatus 10 of the present invention may function and be used as follows. As best seen in FIG. 6, under normal conveyor operating speeds the housing 16 is positioned such that the conveyor 12 extends substantially fully into the housing 16, thereby maximizing the length of the path that the animals travel relative to the stunning force. In this normal position, the animals being transported on the conveyor 12 are exposed to approximately twice the full length of the first electrode 18 (recall that each animal travels the length of the first electrode 18 in the first direction A, turns, and travels the length of the first electrode 18 in direction B), and is exposed to the stunning force for an established normal amount of time. As best seen in FIG. 7, during slowdowns the housing 16 is moved horizontally in the manner described above such that conveyor 12 extends only partially into the housing 16, thereby reducing the length of the path that the animals travel relative to the stunning force. In this adjusted position, the animals being transported on the conveyor 12 are exposed to less of the first electrode 18 than in the normal position, but because the animals are moving slower they continue to be exposed to the stunning force for approximately the same established normal amount of time.

As mentioned, in a second embodiment of the apparatus 110, shown in FIGS. 8 and 9, the conveyor path is not doubled-over within the apparatus as in the above described embodiment, but, instead, the housing 116 is open at both ends and the path of the conveyor 112 is substantially linear and unidirectional in the first direction A through the housing 116. The first electrode 118 is telescopic, i.e., a first portion 118a has a fixed length and a second portion 118b is extendable and retractable relative to the first portion 118a. The housing 116 is constructed having sufficient length to accommodate the maximum length of the first electrode 118 when fully extended. As shown in FIG. 8, under normal conveyor operating speeds the first electrode 118 is relatively extended. As best seen in FIG. 9, during slowdowns the first electrode 118 is relatively retracted. Extension and retraction of the first electrode 118 may be accomplished physically, with assistance, or substantially automatically, as discussed above. Thus, this embodiment provides an alternative method of regulating the path length relative to the stunning force.

In a similar alternative embodiment (not separately shown), the first electrode is not extendable and retractable, but is, instead, provided by longer and shorter lengths of electrically conductive material that can be physically substituted for one another when necessary to achieve substantially the same effect as the embodiment shown in FIGS. 8 and 9. More specifically, under normal conveyor operating speeds a relatively long length of electrically conductive material is used for the first electrode. During slowdowns the relatively long length is removed and replaced by a relatively short length of electrically conductive material in order to reduce the path length relative to the stunning force.

Thus, in the first embodiment of the apparatus 10, the length of the first electrode 18 is changed relative to the path by shortening the path relative to the electrode 18. This is accomplished, as described, by repositioning the housing 16 and the first electrode 18 contained therein relative to the path. In the second embodiment of the apparatus 110, the length of the first electrode 118 is changed relative to the path by physically changing the length of the first electrode 118.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. An apparatus for stunning an animal, wherein the animal is retained upon a transport system which moves the animal at a speed along a path, the apparatus comprising:
a first electrode having a length that is changeable relative to the path;
a second electrode, wherein the animal extends substantially between the first electrode and the second electrode while moving along the path, thereby exposing the animal to a stunning force for an established time period; and
wherein when the speed at which the animal moves along the path changes, the length of the first electrode relative to the path can be changed by a proportional amount to maintain the exposure of the animal to the stunning force for substantially the established time period.

2. The apparatus as set forth in claim 1, wherein the animal is a poultry animal.

3. The apparatus as set forth in claim 2, wherein the transport system is a conveyor and the poultry animal is suspended from a shackle.

4. The apparatus as set forth in claim 1, wherein the length of the first electrode is changed relative to the path by shortening the path relative to the first electrode.

5. The apparatus as set forth in claim 4, wherein the path extends substantially parallel to the first electrode in a first direction, turns, and extends substantially parallel to the first electrode in a second direction, wherein the second direction is substantially opposite the first direction.

6. The apparatus as set forth in claim 5, wherein first electrode is horizontally repositionable relative to the transport system in order to shorten the path relative to the first electrode.

7. The apparatus as set forth in claim 1, wherein the length of the first electrode is changed relative to the path by shortening the length of the first electrode.

8. The apparatus as set forth in claim 7, wherein the first electrode is extendable and retractable to allow for changing the length of the first electrode relative to the path.

9. The apparatus as set forth in claim 1, further comprising:
a housing, wherein the first electrode is located substantially within the housing; and
a movement and positioning system including—
a vertical adjustment subsystem allowing for vertically positioning the first electrode relative to the transport system, and
a horizontal adjustment subsystem allowing for horizontally positioning the first electrode relative to the transport system.

10. The apparatus as set forth in claim 9, further including a liquid conductor, wherein the liquid conductor is contained substantially within the housing and substantially covers the first electrode.

11. The apparatus as set forth in claim 1, further including an electronic controller operable to substantially automatically detect the change in speed and to substantially automatically cause change the length of the first electrode relative to the path by a proportional amount to maintain the exposure of the animal to the stunning force for substantially the established time period.

12. An apparatus for stunning a poultry animal, wherein the poultry animal is retained by a shackle upon a conveyor which moves the poultry animal at a speed along a path, the apparatus comprising:
a first electrode having a length that is changeable relative to the path by repositioning the first electrode horizontally relative to the conveyor;
a second electrode, wherein the poultry animal extends substantially between the first electrode and the second electrode while moving along the path, thereby exposing the poultry animal to an electric current for an established time period; and
wherein when the speed at which the poultry animal moves along the path changes, the first electrode is repositioned horizontally relative to the conveyor by a proportional amount to maintain the exposure of the poultry animal to the stunning force for substantially the established time period.

13. The apparatus as set forth in claim 12, wherein the path extends substantially parallel to the first electrode in a first direction, turns, and extends substantially parallel to the first electrode in a second direction, wherein the second direction is substantially opposite the first direction.

14. The apparatus as set forth in claim 12, further comprising:
a housing, wherein the first electrode is located substantially within the housing; and
a movement and positioning system including—
a vertical adjustment subsystem allowing for vertically positioning the first electrode relative to the conveyor, and
a horizontal adjustment subsystem allowing for horizontally positioning the first electrode relative to the conveyor.

15. The apparatus as set forth in claim 12, further including an electronic controller operable to substantially automatically detect the change in speed and to substantially automatically reposition the first electrode relative to the conveyor and the path by a proportional amount to maintain the exposure of the animal to the stunning force for substantially the established time period.

16. An apparatus for stunning a poultry animal, wherein the poultry animal is retained by a shackle upon a conveyor which moves the poultry animal at a speed along a path, the apparatus comprising:
a first electrode having a length that is changeable relative to the path by extending and retracting the first electrode horizontally relative to the conveyor;
a second electrode, wherein the poultry animal extends substantially between the first electrode and the second electrode while moving along the path, thereby exposing the poultry animal to an electric current for an established time period; and
wherein when the speed at which the poultry animal moves along the path changes, the first electrode is correspondingly extended or retracted horizontally relative to the conveyor by a proportional amount to maintain the exposure of the poultry animal to the stunning force for substantially the established time period.

17. The apparatus as set forth in claim 16, further comprising:
a housing, wherein the first electrode is located substantially within the housing; and
a movement and positioning system including—
a vertical adjustment subsystem allowing for vertically positioning the first electrode relative to the conveyor, and
a horizontal adjustment subsystem allowing for horizontally positioning the first electrode relative to the conveyor and the path.

18. The apparatus as set forth in claim 16, further including an electronic controller operable to substantially automatically detect the change in speed and to substantially automatically correspondingly extend or retract the conveyor by a proportional amount to maintain the exposure of the poultry animal to the stunning force for substantially the established time period.

19. A method of stunning an animal, wherein the animal is retained upon a transport system which moves the animal at a speed along a path, the method comprising the steps of:
(a) providing a first electrode having a length that is changeable relative to the path;
(b) providing a second electrode, wherein the animal extends substantially between the first electrode and the second electrode while moving along the path, thereby exposing the animal to a stunning force for an established time period; and
(c) responding to a change in the speed at which the animal moves along the path by changing the length of the first electrode relative to the path through by a proportional amount to maintain the exposure of the animal to the stunning force for substantially the established time period.

20. The method as set forth in claim 19, wherein step (c) is accomplished by horizontally repositioning the first electrode relative to the transport system.

21. The method as set forth in claim 19, wherein step (c) is accomplished by extending or retracting the first electrode.

22. The method as set forth in claim 19, wherein step (c) includes—
substantially automatically detecting the change in speed; and
substantially automatically causing changing the length of the first electrode relative to the path by a proportional amount to maintain the exposure of the animal to the stunning force for substantially the established time period.
